(19) United States
(12) Patent Application Publication
(10) Pub. No.: US 2018/0307323 A1
(43) Pub. Date: Oct. 25, 2018

(54) METHOD FOR DETECTING A SIGNAL FROM A USER TO GENERATE AT LEAST ONE CONTROL INSTRUCTION FOR CONTROLLING AVIONICS EQUIPMENT OF AN AIRCRAFT, RELATED COMPUTER PROGRAM AND ELECTRONIC DEVICE

(71) Applicant: THALES, COURBEVOIE (FR)

(72) Inventors: Stéphanie LAFON, LE HAILLAN (FR); François MICHEL, LE HAILLAN (FR)

(21) Appl. No.: 15/951,828

(22) Filed: Apr. 12, 2018

(30) Foreign Application Priority Data
Apr. 25, 2017 (FR) 17 00451

(51) Int. Cl. G06F 3/01; G06F 3/16

(52) U.S. Cl. CPC G06F 3/017; B64D 45/00; G06F 3/011; G06F 3/167

(57) ABSTRACT

Disclosed is a method of detecting a signal from a user to generate at least one control instruction for avionics equipment of an aircraft, implemented by an electronic detection device. The method includes the detection of a first user signal, and determination, according to the first detected signal, of a control mode from a plurality of control modes. It includes the detection of a second user signal that is distinct from the first signal, and confirmation of the determined control mode, according to the second detected signal. It includes the detection of a third user signal that is distinct from the second signal, and the selection, according to the third detected signal, of a control instruction from the control instruction(s) associated with the confirmed control mode. At least one of the first, second and third detected signals is a gestural signal.

### CROSS-REFERENCE TO RELATED APPLICATIONS

This application is a U.S. non-provisional application claiming the benefit of French Application No. 17 00451, filed on Apr. 25, 2017, which is incorporated herein by reference in its entirety.

### FIELD

The present invention relates to a method for detecting a signal from a user to generate at least one control instruction for controlling the avionics equipment of an aircraft, wherein the method is implemented by an electronic detection device.

The invention also relates to a non-transitory computer-readable medium including a computer program product comprising software instructions which, when executed by a computer, implement such a detection method.

The invention also relates to an electronic device for detecting a signal from a user to generate at least one control instruction for the avionics equipment of an aircraft.

### BACKGROUND

The invention thus relates to the field of human-machine interfaces, also called HMI, or MMI, for the control of the avionics equipment of an aircraft, and that are preferably intended to be installed in an aircraft cockpit.

Aircraft cockpits are usually equipped with a variety of interactive means that allow a user to interact with the aircraft for the purpose of performing an instruction, such as piloting instruction or modification of the display on a display screen. All of these interactive means then form a means of detection of signals of the user, also called a human-system interface, or HSI.

By way of example, aircraft cockpits comprise interactive means, generally mechanical, of the rotator, contactor, pushbutton or switch type.

In addition, touch-sensitive interactive means make it possible to carry out an instruction by a simple touch on a touch-sensitive surface. In particular, the integration of such touch-sensitive surfaces in a display is already known.

FR 2 695 745 describes a device for detecting gestural signals. Successive gestural signals are detected by sensors equipping a glove worn by the user, and then a control mode is determined to select an associated control instruction.

With such a detection device, however, the user must wear a specific glove, and the risks of erroneous or unintentional control are also relatively high.

### SUMMARY

An object of the invention is therefore to propose a method of detecting a signal of a user, and an associated electronic device, both of which are ergonomic and easy to implement, while limiting the risk of an involuntary instruction of the user.

For this purpose, the subject-matter of the invention is a method for detecting a signal from a user to generate at least one control instruction for avionic equipment of an aircraft, wherein the method is implemented by an electronic detection device comprising:
detection of a first signal of the user;
determination, according to the first detected signal, of a control mode among a plurality of control modes, at least one control instruction being associated with each control mode;
detection of a second signal of the user, the second signal being distinct from the first signal;
confirmation of the determined control mode, according to the second detected signal;
detection of a third signal of the user, the third signal being distinct from the second signal; and
selection, according to the third detected signal, of a control instruction among the control instruction(s) associated with the confirmed control mode;
at least one of the first, second and third detected signals being a gestural signal.

Thus, with the detection method according to the invention, the detection of a second signal that is distinct from the first signal, makes it possible to confirm the previously determined control mode, and then to reduce the risk of error relating to the determination of the control mode.

According to other advantageous aspects of the invention, the method comprises one or more of the following features, taken separately or in any technically feasible combination:
each detected signal is a signal selected among the group consisting of: a gestural signal, a voice signal, a visual signal and a physiological signal;
after determination of the control mode, the method further comprises displaying an indicator, the indicator indicating the determined control mode;
after confirmation of the control mode, the method further comprises the indication of the confirmation of the control mode;
when the signal is a gestural signal, the detection of the signal comprises the measurement of coordinates of the position and the orientation of an element of the human body of the user in a predetermined geometrical reference frame;
the signal is a gestural signal, the detection of the signal further comprises a geometric transformation of position and orientation vectors resulting from the measurement of the coordinates of the position and the orientation of the element of the human body into transformed position and orientation vectors, the geometric transformation corresponding to a change of reference from a first predetermined reference to a second reference that is distinct from the first reference, the second reference being associated with the user's visual field;
the first detected signal is a gestural signal; preferably the pointing of a finger of the user towards a predefined zone;
the control instruction is an instruction for modifying a data display; preferably an enlargement of a display zone, a narrowing of a display zone, or a displacement of a display zone; and
at least two of the first, second and third signals are of different types, each type of signal being selected from the group consisting of: a gestural signal, a voice signal, a visual signal and a physiological signal.

The invention also relates to a non-transitory computer-readable medium including a computer program product comprising software instructions which, when executed by a computer, implement a method as defined above.

The invention also relates to an electronic device for detecting a signal from a user in order to generate at least one control instruction for the avionic equipment of an aircraft, wherein the device comprises:
a first detection module configured to detect a first signal of the user;
a determination module configured to determine, according to the first detected signal, a control mode among a plurality of control modes, at least one control instruction being associated with each control mode;
a second detection module configured to detect a second signal of the user, the second signal being distinct from the first signal;
a confirmation module configured to confirm the determined control mode according to the second detected signal;
a third detection module configured to detect a third signal of the user, the third signal being distinct from the second signal; and
a selection module configured to select, according to the third detected signal, a control instruction among the control instruction(s) associated with the confirmed control mode;
at least one of the first, second and third detected signals being a gestural signal.

According to another advantageous aspect of the invention, the electronic detection device comprises the following feature:
at least two of the first, second and third signals are of different types, each type of signal being selected from the group consisting of: a gestural signal, a voice signal, a visual signal and a physiological signal.

### BRIEF DESCRIPTION OF THE DRAWINGS

These features and advantages of the invention will appear on reading the description which follows, given solely by way of example, and with reference to the appended drawings, wherein:

FIG. 1 shows a schematic representation of an electronic detection device according to the invention and that is configured to detect a signal from a user in order to generate at least one control instruction for the avionics equipment of an aircraft;

FIG. 2 shows a flowchart of a method according to the invention, for detecting a signal of the user to generate at least one control instruction for the avionics equipment of FIG. 1; and

FIGS. 3 to 7 show schematic views of respective use cases, implementing the detection device of FIG. 1.

### DETAILED DESCRIPTION

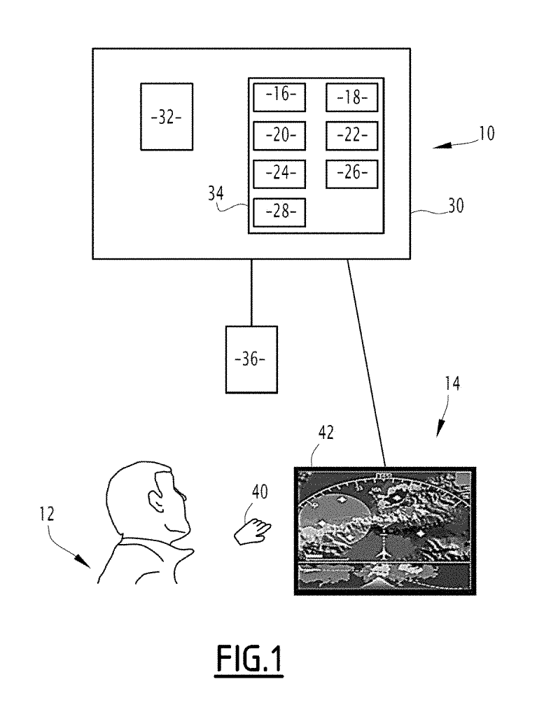

In FIG. 1, an electronic detection device 10 is configured to detect a signal of a user 12 in order to subsequently generate at least one control instruction for the avionics equipment 14 of an aircraft. The aircraft is preferably an airplane. Alternatively, the aircraft may be a helicopter or a drone piloted remotely by a pilot.

The electronic detection device 10 comprises a first detection module 16 that is configured to detect a first signal of the user 12, and a determination module 18 that is configured to determine, according to the first detected signal, a control mode among a plurality of control modes, at least one control instruction being associated with each control mode. The control mode is also called the use context.

The electronic detection device 10 comprises a second detection module 20 configured to detect a second signal of the user 12, the second signal being distinct from the first signal, and a confirmation module 22 is configured to confirm the determined control mode according to the second detected signal.

The electronic detection device 10 comprises a third detection module 24 configured to detect a third signal of the user, the third signal being distinct from the second signal, and a selection module 26 is configured to select, according to the third detected signal, a control instruction from the one or more control instructions associated with the confirmed control mode.

Optionally in addition, the electronic detection device 10 further comprises a display module 28. The display module 28 is, for example, configured to display, after determination of the control mode, an indicator indicating the determined control mode, or is configured to display, after confirmation of the control mode, an indication of the confirmation of the control mode.

In the example of FIG. 1, the electronic detection device 10 comprises an information processing unit 30 in the form, for example, of a processor 32 associated with a memory 34.

In the example of FIG. 1, the electronic detection device 10 is connected to a set of sensors 36 for the detection of the first, second and third signals of the user 12, the set of sensors 36 being, in particular, connected to the first, second and third detection modules 16, 20, 24. The set of sensors 36 comprises at least one sensor.

In the example of FIG. 1, the first detection module 16, the determination module 18, the second detection module 20, the confirmation module 22, the third detection module 24 and the selection module 26, as well as, optionally in addition, the display module 28, are each in the form of software, or a software brick, that is executable by the processor 32. The memory 34 of the detection device 10 is then able to store first detection software that is configured to detect the first signal of the user 12, and determination software that is configured to determine, according to the first detected signal, the control mode, or context of use, among the plurality of control modes, or contexts of use. The memory 34 is also able to store second detection software that is configured to detect the second signal of the user 12, and a confirmation software that is configured to confirm the determined control mode according to the second detected signal. The memory 34 is also able to store third detection software that is configured to detect the third signal of the user, and selection software that is configured to select, according to the third detected signal, the control instruction among the control instruction(s) that is associated with the confirmed control mode. Optionally in addition, the memory 34 is able to store display software, for example that is configured to display, after determination of the control mode, the indicator indicating the determined control mode, or to display, after confirmation of the control mode, the indication of the confirmation of the control mode. The processor 32 is then able to execute the software among the first detection software, the determination software, the second detection software, the confirmation software, the third detection software and the selection software, and, optionally in addition, the display software.

In a variant that is not shown, the first detection module 16, the determination module 18, the second detection module 20, the confirmation module 22, the third detection module 24 and the selection module 26, as well as optionally additionally, the display module 28, each being in the form of a programmable logic component, such as an FPGA (Field Programmable Gate Array), or in the form of a dedicated integrated circuit, such as an ASIC (Application Specific Integrated Circuit).

When the detection device 10 is made in the form of one or more software, i.e. in the form of a computer program, it may also be recorded on a medium (not shown) that is readable by computer. The computer-readable medium may be, for example, a medium that is suitable for storing electronic instructions and is capable of being coupled to a bus of a computer system. For example, the readable medium may be a diskette or floppy disk, an optical disk, a CD-ROM, a magneto-optical disk, a ROM memory, a RAM memory, any type of non-volatile memory (e.g. EPROM, EEPROM, FLASH, NVRAM), a magnetic card or optical card. A computer program including software instructions is then stored on the readable medium.

At least one of the first, second and third detected signals is a gestural signal of the user 12. Each detected signal of the user 12 is preferably a signal selected from the group consisting of: a gestural signal, a voice signal, a visual signal and a physiological signal.

A “gestural signal”, also called gesture signal, is understood to mean a gesture made by the user 12, i.e. a movement of one of the user's members. The gestural signal is, for example, the pointing of a finger of the user 12 towards a predefined zone, a movement of the hand 40, or a movement of the forearm, or a movement of the arm of a user 12. Each gestural signal is, for example, sensed or picked up by a motion sensor or an image sensor of the set of sensors 36.

By voice signal is meant a sound signal emitted by the user 12, in particular by the user's vocal cords. For example, each voice signal may be sensed or picked up by a sound sensor, such as an acoustic microphone, or by an osteophonic microphone placed in contact with the user's face 12.

A “visual signal” is understood to mean a signal generated by one or both eyes of the user 12, for example a movement of the user's gaze 12 or blinking of the eye(s) of the user 12. Each visual signal may be, for example, sensed or picked up by a motion sensor by a gaze tracking sensor.

A “physiological signal” is understood to mean a physiological signal of the user 12, such as the pulse, i.e. the heartbeat of the user 12. Each physiological signal is sensed or picked up by a physiological sensor, such as a heart sensor or an accelerometer arranged in contact with the user 12.

In the example of FIG. 1, the avionics equipment 14 is connected to the detection device 10, and comprises a display screen 42. The display screen 42 is configured to display information relating to the operation of the avionics equipment, and, optionally in addition, is configured to display the information from the display module 28 in the form, for example, of an indicator indicating the determined control mode and/or confirmation of the control mode.

The set of sensors 36 preferably comprises at least two sensors, i.e. a first sensor arranged near the display screen 42, for example at less than 30 cm from the display screen 42, and a second sensor arranged at a distance from the display screen 42, preferably at least 50 cm from the display screen 42, for example at one meter from the display screen 42.

The first sensor is then configured to receive a signal of the user 12 in the form of a direct designation, the signal of the user 12, such as a gestural signal, being then directed at the display screen 42.

The second sensor is then configured to receive a signal of the user 12 in the form of a remote designation, the signal of the user 12, such as a gestural signal, being then directed towards the second sensor, at a distance from the display screen 42.

When the signal of the user 12 is a gestural signal, each detection module 16, 20, 24 is configured to measure coordinates of the position and orientation of an element of the human body of the user 12 in a predetermined geometrical reference, such as the coordinates of the position and the orientation of one of the user's hands 40.

Optionally in addition, when the signal of the user 12 is a gestural signal and especially in the case of remote designation, each detection module 16, 20, 24 is further configured to perform a geometric transformation of the position vectors and orientation resulting from the measurement of the coordinates of the position and the orientation of an element of the human body into transformed position and orientation vectors. The geometric transformation corresponds to a change of reference from a first predetermined reference to a second reference that is distinct from the first reference, the second reference being associated with the visual field of the user 12. In the case of a remote designation, the first predetermined reference is then the reference associated with the second sensor via which the signal of the user 12 is picked up.

The selection module 26 is configured to select the control instruction of the avionics equipment 14 from the third detected signal, such as an instruction to modify a data display, preferably an enlargement of a displayed zone, a narrowing of a displayed zone, or a displacement of a displayed zone.

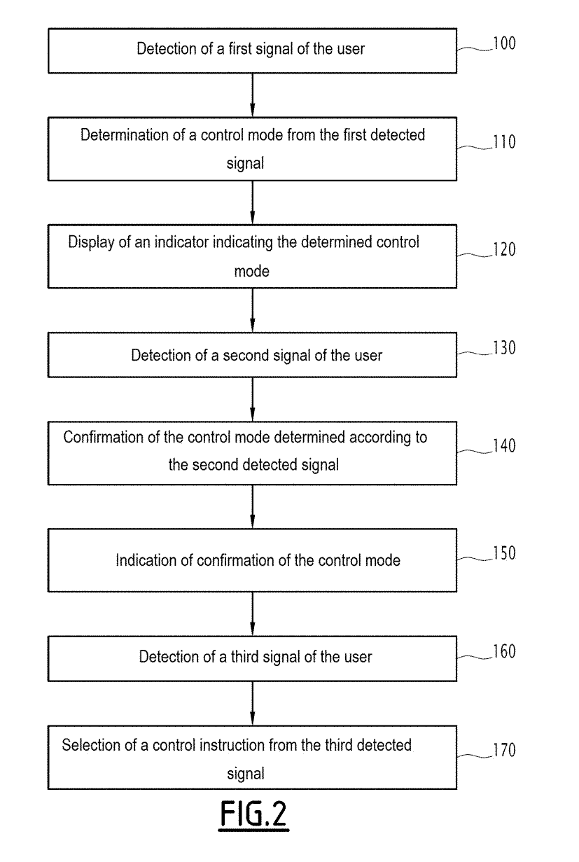

The operation of the detection device 10 according to the invention will now be explained with the aid of FIG. 2 which represents a flowchart of the method according to the invention for the detection of a signal of the user 12 in order to generate at least one control instruction for the avionics equipment 14, the method being implemented by the electronic detection device 10.

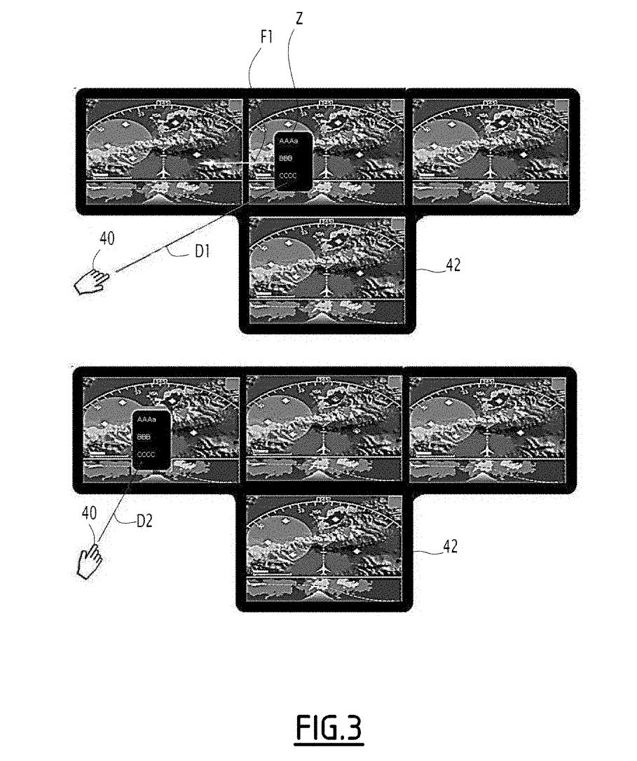

During an initial step 100, the detection device 10 detects a first signal of the user 12 via its first detection module 16. The first detected signal is preferably a gestural signal, as will be explained in more detail below with reference to the examples of FIGS. 3 to 7.

The detection device 10 then determines, via its determination module 18 and in step 110, a control mode among a plurality of control modes, wherein this determination is obtained from the first signal which was detected during the initial step 100. The control mode corresponds to a context of use, according to which the subsequent signals of the user 12 are interpreted, wherein at least one control instruction is associated with each control mode or context of use.

After determination of the control mode 110, the detection device 10 displays in the step 120 and optionally in addition via its display module 28, the indicator indicating the determined control mode. This display of the indicator then allows the user 12 to receive feedback from the detection device 10 on the determined control mode, i.e. the context of use in which its subsequent signals will be interpreted.

In the next step 130, the detection device 10 detects, via its second detection module 20, the second signal of the user 12, wherein the second signal is distinct from the first signal.

Although distinct from the first signal, the second signal may be of the same type as the first signal, wherein the type of the signal is, for example, gestural, vocal, visual or physiological, as indicated above. In other words, the first and second signals of the user 12 may be, for example, gestural signals, while being distinct signals.

The detection device 10 then confirms, via its confirmation module 22 and in step 140, the determined control mode, wherein the confirmation is obtained from the second signal detected in the previous step 130.

After confirmation of the control mode 140, the detection device 10 indicates, optionally in addition during step 150, the confirmation of the control mode. This indication of the confirmation of the control mode is, for example, displayed on the screen 42 via the display module 28. Alternatively, this indication of the confirmation of the control mode may be transmitted in the form of a light signal, for example via an indicator light, or in the form of an audible signal, or in the form of a mechanical signal such as a vibration.

This indication of the confirmation of the control mode then allows the user 12 to receive feedback from the detection device 10 with respect to the confirmation of the control mode, i.e. with respect to the confirmation of the context of use, in which the third signal for sending the desired control instruction to the corresponding avionics equipment 14, will be interpreted.

In the next step 160, the detection device 10 detects, via its third detection module 24, the third signal of the user 12, wherein the third signal is distinct from the second signal.

Although it is distinct from the second signal, the third signal may be of the same type as the second signal. In other words, the second and third signals of the user 12 may be, for example, gestural signals, while being distinct signals.

The first, second and third signals are preferably signals that are distinct from one another in order to limit the risks of confusion between signals by the detection device 10. Similarly, although they are distinct from one another, the first second and third signals may all be of the same type. The first, second and third signals may all be, for example, gestural signals.

At least one of the first, second and third detected signals is a gestural signal.

The detection device 10 finally selects, via its selection module 26 and in step 170, a control instruction from among the control instruction(s) associated with the confirmed control mode, wherein this selection is obtained from the third signal which was detected in the previous step 160.

The selected control instruction is, for example, an instruction to modify a data display, preferably an enlargement of a display zone, a narrowing of a display zone, or a displacement of a display zone.

When the signal detected among the first, second and third signals is a gestural signal, the detection of the corresponding signal 100, 130, 160 comprises the measurement of coordinates of the position and orientation of an element of the body of the user 12 in a predetermined geometric reference.

Optionally in addition, when the signal detected among the first, second and third signals is a gestural signal and especially in the case of a remote designation, the detection of the corresponding signal 100, 130, 160 further comprises a geometric transformation of position vectors and orientation resulting from the measurement of the coordinates of the position and the orientation of the element of the human body, into transformed position and orientation vectors. The geometric transformation corresponds to a change of reference from the first predetermined reference to a second reference that is distinct from the first reference, wherein the second reference is associated with the visual field of the user 12. Those skilled in the art will then understand that the first predetermined reference then corresponds to the reference in which the detection of the corresponding sign signal is effected in remote designation.

In the example of FIG. 3, the user 12 designates in the direction D, with a hand 40, preferably with a finger, a zone Z displayed on the display screen 42, with, for example, a touch-sensitive format, which appears to him to be too far from his hand 40. The pointing at the zone Z with the hand 40 or with the finger is then the first signal of the user 12. Then, the user 12 closes, for example, his fist to confirm the mode order, or context of use. This then makes it possible to secure entry into the control mode selected via the first signal. The closing of the fist is then the second signal of the user 12. Alternatively, the second signal of the user 12 may be a rotation of the wrist, or, for example, a sound signal emitted by the user 12.

The user then moves his hand 40 along the arrow F1 towards the location where he wishes to move the zone Z by in the direction D2 pointing towards the new desired location of the zone Z. The movement of the hand is then the third signal of the user 12. Alternatively, the third signal of the user 12 may be a voice signal, such as the name of another screen of the cockpit, in order to move the zone Z to this other screen.

In an example similar to that of FIG. 3, when the zone Z towards which the user 12 points in the direction D1, contains a value, then the aforementioned succession of signals makes it possible to copy the value and then paste it into the new desired location in the direction D2.

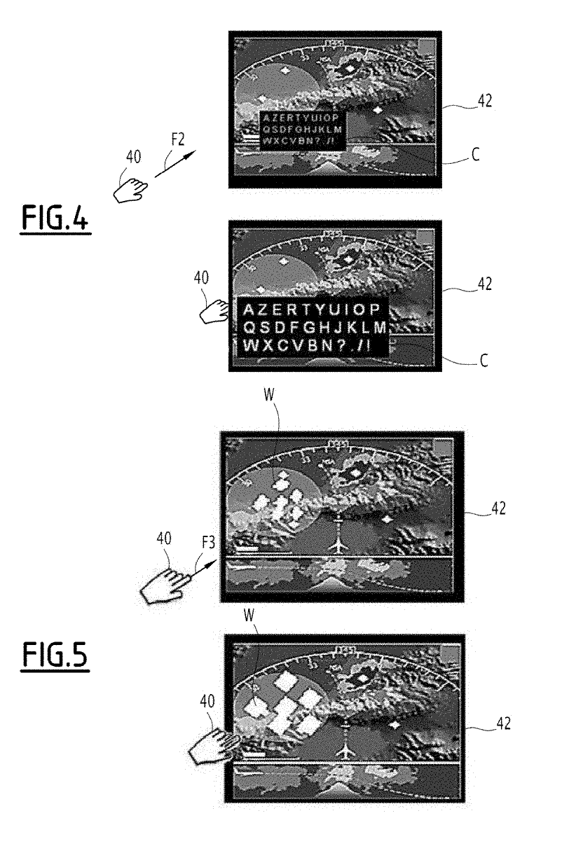

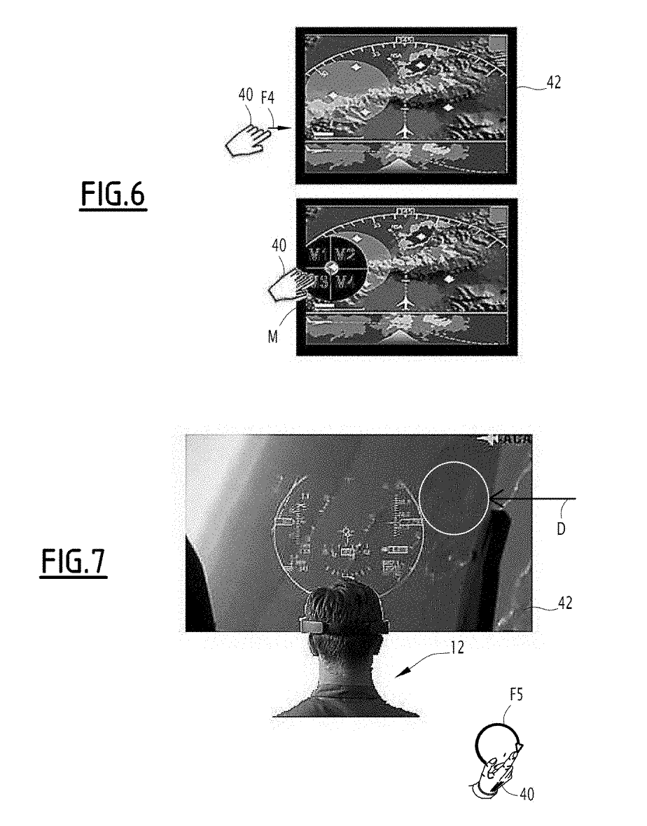

In the example of FIGS. 4 to 6, the user 12 begins by designating with his hand 40, preferably with a finger, a zone of the display screen 42. The pointing towards the screen 42 with the hand 40 or with the finger is then the first signal of the user 12. Then, the user 12 makes another gesture, such as closing the fist, or emitting a sound signal, as a second signal to confirm the control mode which was determined via the first signal. This other gesture, such as closing the fist, is then the second signal of the user 12. Finally, the user 12 approaches his hand 40 towards the display screen 42 along the arrow F2 in the example of FIG. 4, respectively along arrow F3 in the example of FIG. 5, or respectively along arrow F4 in the example of FIG. 6. The movement of the hand along arrow F2, respectively along arrow F3, or respectively along the arrow F4, is then the third signal of the user 12.

In the example of FIG. 4, when the user 12 approaches his hand 40 towards a keyboard C, this third signal causes the keyboard C to be enlarged on the display screen 42, in order to facilitate interaction of the user 12 with the avionics equipment 14, especially in case of turbulence.

In the example of FIG. 5, when the user 12 approaches his hand towards a set of indicators that are too close to each other, for example a set of crossing points W on a navigation screen, then this third signal results in a local enlargement of the set of indicators in order to facilitate the touch-sensitive selection of one particular indicator.

In the example of FIG. 6, when the user 12 approaches his hand 40 towards the screen 42, this third signal causes the appearance, i.e. the opening of a dedicated menu M, such as a menu of graphic objects in order to avoid multiplying the touch-sensitive support.

In the example of FIG. 7, the user 12 observes a screen via an augmented reality headset, and makes a first gestural signal through remote designation, for example through his hand 40 positioned in the extension of the armrest. The remote designation pointing by the hand 40 or the finger, is then the first signal of the user 12. Then, the user 12 closes, for example, his fist to confirm the control mode, or, in other words, to secure entry into the control mode. The closing of the fist is then the second signal of the user 12. Alternatively, the second signal of the user 12 may be by a rotation of the wrist, or a sound signal of the user 12, such as a voice signal.

The user 12 then designates objects on the screen which he observes in the virtual reality helmet, wherein the designation is, in this case and as indicated above, with a transfer function making it possible to point remotely at the objects of the screen. The virtual reality helmet also displays a visual feedback D indicating at each moment the designated object, for example via a movement of the hand according to arrow F5. The movement of the hand is then the third signal of the user 12, and allows, for example, and in a similar manner to the previous examples with reference to FIG. 3, the copy/pasting or displacement of a display or information zone towards other displays of the cockpit, in particular for the head-down or head-up display of the co-pilot to share information.

Those skilled in the art will understand that the detection device 10 has many applications making it possible to facilitate the interaction of the user 12 with different avionics equipment 14, as in the following complementary examples:
interactions with a flight management system (FMS)
   opening of copy/pasting menu(s) for the entry and/or modification of the flight plan (waypoints, constraints, terminal or en route procedures) or the lateral or vertical trajectory (continuous wire that connects crossing points),
   opening of copy/pasting menu(s) for local enlargement of the display and/or selection of diversion airports, decision points (equivalent points in travel time, points of no return), radionavigation beacons;
interactions with a weather function of the flight management system or a weather radar system or an electronic flight bag (EFB), or interaction with a Terrain Awareness and Warning System (TAWS), or interaction with a traffic monitoring system (TCAS);
   local zoom-in of weather cells (thunderstorms, cumulonimbus, jetstreams, etc.) in two or three dimensions, of geographical zones, of airspace zones,
   zoom-in/zoom-out of an aeronautical chart, displacement(s) on the aeronautical chart, local enlargement of the aeronautical chart, selection and/or copy/pasting of objects of the aeronautical chart;
interactions with a radio management system (RMS):
   opening of copy/pasting menu(s) for entering and/or modifying radio frequencies;
interactions with Airport Navigation Function (ANF) equipment:
   opening of copy/pasting menu(s) for entry and/or modification of the taxiing plan (also known as the routing plan): ports, taxiways, runways, crossing constraints, one-way traffic;
interactions with an autopilot:
   opening of copy/pasting menu(s) for entry and/or modification of speed, altitude, roll instructions etc. in order to activate guidance modes on the 3 axes of the aircraft;
interactions with a display system:
   scrolling of pages, opening of submenu(s) (motors, electronics, hydraulics . . . );
interactions with a Flight Warning System (FWS):
   opening of copy/pasting menu(s) for display and/or selection of a procedure to be executed (list of actions to be performed), for validation of actions;
interactions with multiple avionics systems:
   selection by displacement, local enlargement of a zone on an aeronautical chart (on EFB for example), then copying of a radio frequency corresponding to an airspace on the aeronautical chart in question, then selection of the RMS format (Radio), opening of the RMS voice frequency input menu, and pasting of the frequency;
   selection of the FMS format, copying of the flight path or flight plan, then selection of the weather format, pasting of the flight plan and opening of the weather menu controlling the display of winds/temperatures related to the flight plan, copying of the wind/temperature list, selection of the FMS format, pasting of the winds/temperatures in the FMS; and
   selection by local displacement/zooming-in of a weather zone to be avoided on a weather display, then copying of the geometric shape to be avoided, then selection of the FMS format, opening a local weather diversion flight plan calculation menu, and pasting the weather zone, resulting from the calculation of a new flight plan by the FMS to avoid the zone.

Those skilled in the art will observe that, in several of the examples described above, at least two of the first, second and third signals are of different types, wherein each type of signal is chosen from the group consisting of: a gestural signal, a voice signal, a visual signal and a physiological signal.

It is thus conceivable that the method for detecting a signal of a user according to the invention, and the associated electronic detection device 10, should be ergonomic and easy to implement, while limiting the risk of involuntary control by the user.

The detection device 10 then makes it easier for the user 12 to control the avionics equipment 14 connected to the detection device 10.

1. Method for detecting a signal of a user for generating at least one control instruction for avionics equipment of an aircraft, wherein the method is implemented by an electronic detection device and comprises:
detection of a first user signal;
determination, according to the first detected signal, of a control mode among a plurality of control modes, wherein at least one control instruction is associated with each control mode;
detection of a second user signal, the second signal being distinct from the first signal;
confirmation of the determined control mode, according to the second detected signal;
detection of a third user signal, the third signal being distinct from the second signal; and
selection, according to the third signal detected, of a control instruction from among the control instruction(s) associated with the confirmed control mode;
at least one of the first, second and third detected signals being a gestural signal.

2. Method according to claim 1, wherein each detected signal is a signal selected from the group consisting of: a gestural signal, a voice signal, a visual signal and a physiological signal.

3. Method according to claim 1, wherein, after determination of the control mode, the method further comprises:
display of an indicator, the indicator indicating the determined control mode.

4. Method according to claim 1, wherein, after confirmation of the control mode, the method further comprises:
indication of the confirmation of the control mode.

5. Method according to claim 1, wherein, when the signal is a gestural signal, the detection of the signal includes measuring the coordinates of the position and orientation of an element of the body of the user in a predetermined geometric reference.

6. Method according to claim 5, wherein, when the signal is a gestural signal, the detection of the signal further comprises a geometric transformation of position and orientation vectors resulting from the measurement of the coordinates of the position and the orientation of the element of the human body, into transformed position and orientation vectors, wherein the geometric transformation corresponds to a change of reference from a first predetermined reference to a second reference that is distinct from the first reference, the second reference being associated with the visual field of the user.

7. Method according to claim 1, wherein the first detected signal is a gestural signal.

8. Method according to claim 7, wherein the first detected signal is the pointing of a finger of the user towards a predefined zone.

9. Method according to claim 1, wherein the control instruction is an instruction for modification of a data display.

10. Method according to claim 9, wherein the control instruction is an enlargement of a display zone, a narrowing of a display zone, or a displacement of a display zone.

11. Method according to claim 1, wherein at least two of the first, second and third signals are of different types, each type of signal being chosen from the group consisting of: a gestural signal, a voice signal, a visual signal and a physiological signal.

12. Non-transitory computer-readable medium including a computer program comprising software instructions which, when executed by a computer, implement a method according to claim 1.

13. Electronic device for detecting a signal of a user for generating at least one control instruction for the avionics equipment of an aircraft, wherein the device comprises:
a first detection module that is configured to detect a first signal of the user;
a determination module that is configured to determine, according to the first detected signal, a control mode among a plurality of control modes, wherein at least one control instruction is associated with each control mode;
a second detection module that is configured to detect a second user signal, wherein the second signal is distinct from the first signal;
a confirmation module that is configured to confirm the determined control mode, according to the second detected signal;
a third detection module that is configured to detect a third signal of the user, wherein the third signal is distinct from the second signal; and
a selection module that is configured to select, according to the detected third signal, a control instruction from the one or more control instructions associated with the confirmed control mode;
at least one of the first, second and third detected signals being a gestural signal.

14. Device according to claim 13, wherein at least two of the first, second and third signals are of different types, wherein each signal type is selected from the group consisting of: a gestural signal, a voice signal, a visual signal and a physiological signal.
